(19) United States
(12) Patent Application Publication
(10) Pub. No.: US 2006/0061533 A1
(43) Pub. Date: Mar. 23, 2006

(54) Driving an active matrix display

(75) Inventors: Mark Thomas Johnson, Eindhoven (NL); Alexander Victor Henzen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/526,182

(22) PCT Filed: Aug. 4, 2003
(86) PCT No.: PCT/IB03/03469

§ 371 Date: Mar. 1, 2005

(30) Foreign Application Priority Data
Sep. 6, 2002 (EP) 02078678.6

(51) Int. Cl. G09G 3/36

(52) U.S. Cl. 345/92

(57) ABSTRACT

The active matrix display comprises a matrix of display pixels (10) which are associated with intersections of crossing select electrodes (11) and control electrodes (12). A select driver (2) supplies a select signal (SE) to the select electrodes (11). A control driver (3) supplies control signals (D)A) to the control electrodes (12). A voltage level generator (5) supplies a plurality of different voltage levels (VBi) to level electrodes (13) of the active matrix display. The active matrix display further comprises select circuits (6) which are arranged to selectively couple the voltage levels (VBi) on the voltage level electrodes (13) to the pixels (10) to supply one of the plurality of different voltage levels (VBi) to a particular one of the pixels (10) in dependence on the select signal (SE) and the control signal (DA) associated with this particular pixel (10). The select signal (SE) indicates whether the particular pixel (10) is selected and the control signal (DA) indicates which one of said plurality of different voltage levels (VBi) has to be supplied to the particular one of the pixels (10) when selected.

The invention relates to an active matrix display, a method of driving an active matrix display, and a display apparatus comprising an active matrix display.

U.S. Pat. No. 6,184,854 discloses a drive system of a matrix display which generates different bias levels with a DAC. The bias levels are supplied to the row and column drivers. This prior art has the drawback that complex drivers are required which have to handle a plurality of bias voltage levels.

It is an object of the invention to provide a matrix display in which less complex data drivers are used.

A first aspect of the invention provides an active matrix display as claimed in claim 1. A second aspect of the invention provides a method of driving a matrix display as claimed in claim 7. A third aspect of the invention provides a display apparatus as claimed as claimed in claim 8. Advantageous embodiments are defined in the dependent claims.

The active matrix display comprises a matrix of display pixels which are associated with intersections of crossing select electrodes and control electrodes. A select driver supplies a select signal to the select electrodes. A control driver supplies control signals to the control electrodes. A voltage level generator supplies a plurality of different voltage levels to level electrodes of the active matrix display. The active matrix display further comprises select circuits which are arranged for selectively coupling the voltage levels on the voltage level electrodes to the pixels to supply one of the plurality of different voltage levels to a particular one of the pixels in dependence on the select signal and the control signal associated with this particular pixel. The select signal indicates whether the particular pixel is selected and the control signal indicates which one of said plurality of different voltage levels has to be supplied to the particular one of the pixels when selected.

The drive scheme in accordance with the first aspect of the invention enables to supply many voltage levels to the pixels while a simple control driver can be used which only needs to control the selection of the plurality of the different voltage levels. The voltage range of the control driver is only determined by the voltage levels required to control the select circuits and not any more by the voltages required across the pixels. In prior art matrix displays, the control driver is the data driver, and the control electrodes are the data electrodes. In the matrix display in accordance with the first aspect of the invention, extra level electrodes are implemented to supply the actual voltage to the pixels and the prior art data drivers are replaced by the control drivers which only need to control the select circuits. Thus, the complexity of and the requirements imposed on of the prior art data drivers decreases. This is very important as the amount of output stages connected to the large amount of data/control electrodes is very high. However, the complexity of the display increases as the select circuits and the extra level electrodes are required.

U.S. Pat. No. 4,833,464 discloses the control of the grey level of a pixel of an electrophoretic display dependent on a duration of a pulse supplied to the pixel. It is a drawback of this prior art that only a limited amount of grey levels is possible as in practical applications wherein the complete field of data has to be displayed within a predefined field period both the minimum and the maximum duration of the pulses is limited.

In an embodiment as defined in claim 2, the different voltage levels are available in a single voltage signal during successive select periods. Each one of the pixels needs to be associated with a single level electrode only. The select circuit of a particular pixel is controlled by the associated select and control signal to supply the single voltage level during the appropriate one of the select periods to the pixel, such that the required voltage level is supplied to the pixel. Such a drive of the matrix display is easily possible by supplying different voltage levels to the level electrodes during different sub-fields if the matrix display is sub-field driven. All the level electrodes may receive the same voltage level during a particular sub-field.

In an embodiment as defined in claim 3, the select circuit supplies the single voltage to the particular pixel via a single drive switch and a single select switch. The drive switch is arranged to supply the single voltage to the pixel when activated. When activated by the associated select signal, the select switch supplies the associated control signal to the control input of the drive switch. Now the data driver has to control a single drive switch per pixel, only two level data drivers can be used. Such data drivers have a simple construction and are readily available. The extra circuitry per pixel is limited to a single select switch and a single drive switch.

In an embodiment as defined in claim 4, at least two voltage signals are generated which each may have one level or a subset of the required levels. All the voltage signals together supply all the voltage levels required. All the voltage signals, each via its own level electrode, are selectively supplied to all the pixels. The select circuits determine which one of the voltage levels, if any, is supplied to a particular pixel during a particular select period. The use of more than one voltage signal allows decreasing the number of select periods required to select all the pixels, and thus increases the refresh rate of the pixels.

In an embodiment as defined in claim 5, a single pixel is coupled to a plurality of level electrodes via a plurality of drive switches, each level electrode carries a different voltage signal. During each select period it is possible to supply the required voltage signal which has the required voltage level to the pixel by activating the correct drive switch. The control circuit might contain a decoder (for example, a multiplexer) which decodes the drive switch to be closed from a voltage level on several control electrodes which all are associated with the same pixel. For example, if four drive switches are implemented to selectively couple four different voltage levels to the pixel, two control electrodes each having two levels will be able to determine which one of the drive switches should be closed, if any, when the pixel is selected as indicated by the associated select electrode. Off course, many alternatives are possible, for example, more than two levels may be used on the control electrodes to minimize the number of control electrodes required per pixel.

In an embodiment as defined in claim 6, the matrix display is an electrophoretic display. Such a display has the advantage that the optical state of the pixels is kept during a relatively long time when not refreshed. This enables a low refresh rate which may occur when a single voltage signal comprising all the voltage levels successively in time is available at a single level electrode per line of pixels.

These and other aspects of the invention are apparent from and will be elucidated with reference to the embodiments described hereinafter.

In the drawings:

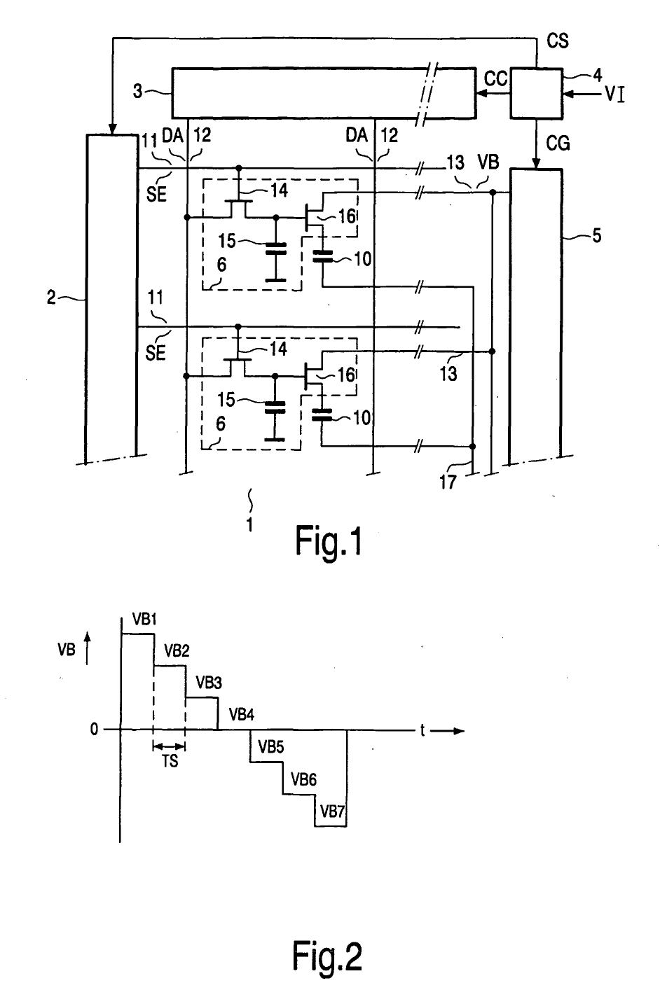

FIG. 1 shows an embodiment of a display apparatus in accordance with the invention,

FIG. 2 shows an example of a single voltage signal,

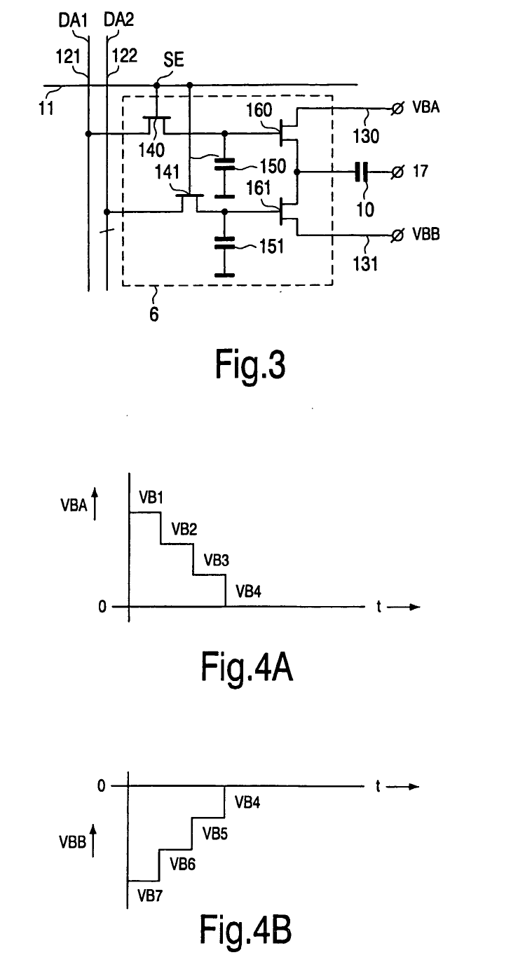

FIG. 3 shows an embodiment of a display cell in accordance with the invention, and

FIG. 4 shows an example of a plurality of voltage signals.

The same references in different Figs. refer to the same signals or to the same elements performing the same function.

FIG. 1 shows an embodiment of a display apparatus in accordance with the invention. The display apparatus comprises a matrix display 1, a select driver 2, a control driver 3, a voltage level generator 5 and a signal processing circuit 4. In FIG. 1, for the sake of clarity only two display cells of the matrix display 1 are shown. In a practical implementation, the matrix display 1 comprises far more display cells. The same elements of the display cells are indicated with the same references.

The select driver 2 supplies select signals SE to the select electrodes 11. Usually, the select driver 2 is the row driver, and the select electrodes 11 extend in the horizontal direction. Usually, the select driver 2 selects all the rows of pixels 10 associated with each one of the select electrodes 11 one by one during a frame period.

The control driver 3 supplies control signals DA to the control electrodes 12. In prior art matrix displays, the control driver 3 is the data driver which supplies data signals to column electrodes extending in the vertical direction. If these data signals must be able to have a plurality of levels to generate sufficient grey levels, complex data drivers are required. In accordance with an aspect of the invention, the control driver 3 which replaces the prior art data driver supplies control signals DA which will comprise less levels as the prior art data signals. Consequently, the control driver 3 will be less complicated than the prior art data driver. On the other hand, the matrix display will become more complicated as the plurality of levels still have to be provided across the display pixels 10. This plurality of levels is now supplied to the pixels via the extra level electrodes 13. In the embodiment in accordance with the invention as shown in FIG. 1, all the level electrodes 13 are interconnected and carry the voltage signal VB which has a plurality of voltage levels VBi which occur successively as elucidated with respect to FIG. 2.

The signal processing circuit 4 receives an input signal VI to be displayed on the matrix display and supplies the control signals CS, CC and CG. The control signal CS is supplied to the select driver 2 to select the select electrodes 11 one by one. The voltage level generator 5 receives the control signal CG to supply the appropriate voltage level VBi of the voltage signal VB. Several possibilities exist to supply the voltage levels VBi. For example, in a preferred embodiment, the select time TS during which a particular voltage level Vbi is present on the level electrodes 13 is equal to the sub-frame period during which all the rows of pixels 10 of the matrix display are selected. The next voltage level VBi is present on the level electrodes 13 during the next sub-frame period.

The display cells each comprise a pixel 10, a select circuit 6 and part of the select electrodes 11, the control electrodes 12, and the level electrodes 13. In the embodiment of the cell shown in FIG. 1, the selects circuit 6 comprises a select switch 14, a drive switch 16 and a storage capacitor 15. The select switch 14 which is a thin-film transistor has a main current path coupled between the control electrode 12 and one end of the storage capacitor 15. The other end of the storage capacitor 15 is coupled to a reference potential. The control electrode of the select switch 14 is coupled to the select electrode 11. The drive switch 16 has a control input coupled to a junction of the storage capacitor 15 and the main current path of the select switch 14, and a main current path arranged between one end of the pixel 10 and the level electrode 13. The other end of the pixel 10 is connected to the common electrode. All the pixels 10, or groups of pixels 10 are connected to the (same) common electrode.

The operation of the matrix display 1 is elucidated with respect to FIG. 2.

FIG. 2 shows an example of a single voltage signal VB which has a plurality of voltage levels VBi which occur successively during select period TS. If, for example, the single voltage signal VB is supplied to all the level electrodes 13 in common, a particular voltage level VBi is present during the complete sub-frame period during which the rows of pixels 10 are successively selected one by one by the select driver 3. A row of pixels 10 is selected by supplying an appropriate pulse during a row select period to the associated select electrode 11. During each row select period, the control driver 2 supplies control signals DA in parallel to the pixels 10 of the selected row to control the state of the pixels 10 dependent on the image line to be displayed in the selected row.

If a particular select electrode 11 is selected by supplying a select signal with a high level, the select switches 14 associated with this select electrode 11 conduct, and the control signals DA which are present in parallel on the control electrodes 12 are supplied to the storage capacitors 15. The drive switches 16 associated with control electrodes 12 on which the control signals DA have a high level, will become conductive and couple the voltage level VBi present on level electrode 13 associated with the selected select electrode 11 to the associated pixel 10. The drive switches 16 associated with control electrodes 12 on which a low level is present, will stay non-conductive and the associated pixels 10 will maintain the voltage state they are in. The selection of the rows of pixels 10 is repeated until all the voltage levels VBi have been presented to all the level electrodes 13.

In the embodiment of the invention as shown in FIG. 1, during a particular sub-frame period, the voltage level VBI is present on all the level electrodes 13, and all the select electrodes 11 are selected one by one. The control signals DA determined to which pixels 10 this particular voltage level VB1 is presented. Then, again during a sub-frame period, the next voltage level VB2 is present on all the level electrodes 13 and again all the select electrodes 11 are selected one by one. Again the control signals DA determine to which pixels 10 this particular voltage level VB2 is presented. Thus, a frame which lasts the number of voltage levels VBi times the sub-frame period, all the pixels 10 had an opportunity to be connected to one of the voltage levels VBi. A complete addressing period may last several frames. A lot of grey levels of the pixels 10 are possible. For example, the voltage level VB2 or the voltage level VB3 may be present on a particular pixel 10 during the complete addressing period, resulting in a first or a second grey level, respectively. A grey level in-between the first and the second grey level may be obtained by connecting the pixel 10 during some of the frame periods of the complete address cycle to the voltage level VB2 and during the rest of the frame periods of this complete address cycle to the voltage level VB3.

It is also possible that with every row of pixels 10 a separate level electrode 13 is associated. Different level electrodes 13 may carry different voltage levels VBi during the same frame period. It is also possible to change the voltage level VBi at the level electrodes 13 after each row select period.

In the embodiment shown in FIG. 1, the drive switches 16 have to be reset to become non-conductive before the start of the following frame. Otherwise, drive switches 16 which were conductive will be connected to the successive voltage level VBi without being addressed to do so. All the drive switches 16 can be reset within a short time period, for example a line period, by first selecting all the select electrodes 11 by supplying a high level and by supplying a low level on all the data electrodes 12. All the select switches 11 are conductive, all capacitors 15 will be discharged, and all the switches 16 will become non-conductive.

It is also possible to omit the capacitors 15, whereby the drive switches will only become conductive during the select period and thereafter become non-conductive, as required. The voltage across the pixels 10 will be maintained by the pixel capacitance. An extra capacitor may be arranged in parallel with the pixel capacitance (not shown in FIG. 1) if the value of the pixel capacitance is too low to maintain the voltage across the pixels 10 long enough.

FIG. 3 shows an embodiment of a display cell in accordance with the invention. Now, each display cell comprises the pixel 10, two drive switches 160, 161, two select switches 140, 141, and two storage capacitors 150, 151.

The pixel 10 has one end connected to the common electrode 17, and another end connected to a junction of main current paths of the drive switches 160 and 161. The other end of the main path of the drive switch 160 receives the voltage signal VBA on the level electrode 130, and the other end of the main path of the drive switch 161 receives the voltage signal VBB on the level electrode 131.

The control electrode of the drive switch 160 is connected to the storage capacitor 150 and to the main current path of the select switch 140. The other end of the storage capacitor 150 is connected to a reference level. The other end of the main path of the select switch 140 is connected to a control electrode 121. The control input of the select switch 140 is connected to the select electrode 11.

The control electrode of the drive switch 161 is connected to the storage capacitor 151 and to the main current path of the select switch 141. The other end of the storage capacitor 151 is connected to a reference level. The other end of the main path of the select switch 141 is connected to a control electrode 122. The control input of the select switch 141 is connected to the select electrode 1.

The operation of this display cell is elucidated with respect to FIG. 4.

FIG. 4 show an example of a plurality of voltage signals. The voltage signal VBA comprises the positive voltage levels VBi which succeed each other in time, and the voltage signal VBB comprises the negative voltage levels VBi which succeed each other in time. During the row select period during which the row of pixels 10 associated with the select electrode 11 are selected (in this example when the select signal SE on the select electrode 11 has a high level) both the select switches 140 and 141 are conductive and the data signals DA1 and DA2 are supplied to the storage capacitors 150 and 151, respectively. Depending on the level of the data signals DA1 and DA2, none or one of the drive switches 160 and 161 is conductive. If none of the drive switches is conductive, the previous voltage state of the pixel 10 is maintained. If the drive switch 160 is conductive, the voltage signal VBA is supplied to the pixel 10, and if the drive switch 161 is conductive, the voltage signal VBB is supplied to the pixel 10.

In a frame, all the select electrodes 11 are selected one by one for each of the voltage levels VBi of the voltage signals VBA and VBB. Thus, during the frame, for each pixel 10, it is possible to select out of all possible voltage levels VBi. As now, during the frame, only four successive voltage levels VBi have to be presented to the level electrodes 130 and 131, instead of seven levels as shown in FIG. 2, the embodiment in accordance with the invention as shown in FIG. 3 requires less time to perform a complete addressing cycle, and thus the refresh rate of the pixels is higher.

Although with respect to FIG. 3 and FIG. 4 two voltage signals VBA and VBB are shown, it is also possible to supply more than two voltage signals VB, each via a separate level electrode 13. It is not required that the voltage signals VB have different levels.

The number of control electrodes 12 required to select between the voltage signals VB depends on the number of voltage signals VB and on the number of levels on the control electrodes 12. If two control electrodes 12 are implemented, and simple control drivers 3 are used which are able to supply two level control signals DA only, as elucidated, two select switches 14 can be controlled. In principle it would be possible to control four states. In one state, the state of the pixel is maintained, in the other states, one of three voltage signals VB can be selected. A decoder is required to translate the control signals DA on the control electrodes into control signals suitable for the switches. With more control electrodes 12 per pixel 10 even more switches can be controlled, either directly or via a decoder.

It is also possible to use more than two levels on the control electrodes 12 to switch several select switches 14.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An active matrix display comprising
a matrix of display pixels being associated with intersections of crossing select electrodes and control electrodes,
a select driver for supplying select signals (SE) to the select electrodes,
a control driver for supplying control signals (DA) to the control electrodes,
a voltage level generator for generating a plurality of different voltage levels (VBi), and
select circuits, each being coupled between an associated one of the display pixels and the voltage level generator for supplying a selected one of said plurality of different voltage levels (VBi) via at least one voltage level electrode to the associated one of the display pixels in dependence on both the select signals (SE) indicating whether the associated one of the pixels is selected and the control signals (DA) indicating which one of said plurality of different voltage levels (VBi) has to be supplied to the associated one of the pixels.

2. An active matrix display as claimed in claim 1, characterized in that said voltage level generator is adapted for supplying the plurality of different voltage levels (VBi) as a single voltage signal (VB) having different levels occurring successively in time during select periods (TS), and in that the select driver is adapted for selecting the associated one of the pixels during each of the select periods (TS), the control signal (DA) determining whether a particular one of the plurality of different voltage levels (VBi) is supplied to the associated one of the pixels.

3. An active matrix display as claimed in claim 2, characterized in that the select circuits each comprise
a single drive switch having a main current path coupled between the associated one of the pixels and a single voltage level electrode carrying the single voltage signal (VB), and
a single select switch having a main current path being arranged between one of the control electrodes and a control input of said single drive switch, and having a control input coupled to one of the select electrodes.

4. An active matrix display as claimed in claim 1, characterized in that said voltage level generator is adapted for supplying at least two voltage signals (VBA, VBB) each comprising at least one of the plurality of different voltage levels (VBi), and in that the select driver is adapted for selecting the associated one of the pixels during each select period (TS), the control signal (DA) determining whether one of the at least two voltage signals (VB1, VB2) is supplied to the associated one of the pixels.

5. An active matrix display as claimed in claim 4, characterized in that said matrix display comprises at least two voltage level electrodes, each for carrying one of the at least two voltage signals (VB1, VB2),
the select driver comprises
a plurality of drive switches, each having a main current path coupled between the associated one of the pixels and one of the at least two voltage level electrodes, and
a plurality of select switches, each being coupled between a same one of the select electrodes and an associated control input of one of the at least two drive switches, and
in that the control driver is adapted for supplying the control signals (DA) via at least two of the control electrodes to associated control inputs of the plurality of select switches.

6. An active matrix display as claimed in claim 1, characterized in that the pixels comprise electrophoretic material.

7. A method of driving an active matrix display comprising a matrix of display pixels being associated with intersections of crossing select electrodes and control electrodes, the method comprising
supplying a select signal (SE) to the select electrodes,
supplying a control signal (DA) to the control electrodes,
generating a plurality of different voltage levels (VBi), and
supplying a selected one of said plurality of different voltage levels (VBi) via at least one voltage level electrode to an associated one of the display pixels in dependence on both the select signal (SE) indicating whether the associated one of the pixels is selected and the control signal (DA) indicating which one of said plurality of different voltage levels (VBi) has to be supplied to the associated one of the pixels.

8. A display apparatus with an active matrix display comprising
a matrix of display pixels being associated with intersections of crossing select electrodes and control electrodes,
a signal processing circuit for receiving an input display signal (VI) and for supplying a first control signal (CC), a second control signal (CS), and a third control signal (CG),
a select driver for supplying select signals (SE) to the select electrodes under control of the first control signal (CS),
a control driver for supplying control signals (DA) to the control electrodes under control of the second control signal (CC),
a voltage level generator for generating a plurality of different voltage levels (VBi) under control of the third control signal (CG),
select circuits, each being coupled between an associated one of the display pixels and the voltage level generator, for supplying a selected one of said plurality of different voltage levels (VBi) to the associated one of the display pixels in dependence on both the select signals (SE) indicating whether the associated one of the pixels is selected and the control signals (DA) indicating which one of said plurality of different voltage levels (VBi) has to be supplied to the associated one of the pixels.
